(19) United States
(12) Patent Application Publication
(10) Pub. No.: US 2024/0176863 A1
(43) Pub. Date: May 30, 2024

(54) SYSTEM-ON-CHIP INCLUDING A RESOURCE ISOLATION SYSTEM AND METHOD FOR MANAGING THE CORRESPONDING RESOURCE ISOLATION

(71) Applicants: STMicroelectronics (Rousset) SAS, Rousset (FR); STMicroelectronics (Grand Quest) SAS, Le Mans (FR); STMicroelectronics (Alps) SAS, Grenoble (FR)

(72) Inventors: Fabrice Cheruel, St-Georges-du-Bois (FR); Dragos Davidescu, Lambesc (FR); Nicolas Anquet, Grenoble (FR)

(21) Appl. No.: 18/514,795

(22) Filed: Nov. 20, 2023

(30) Foreign Application Priority Data
Nov. 25, 2022 (FR) 2212349

(51) Int. Cl. G06F 21/44; G06F 21/71

(52) U.S. Cl. CPC G06F 21/44; G06F 21/71

(57) ABSTRACT

The system-on-chip includes at least one microprocessor domain including a microprocessor and at least one resource; and a resource isolation system including a filtering circuit for each resource and configured to detect a security, privilege and compartmentalization access rights violation for the resource, by transactions arriving at the resource. The filtering circuit is configured, in the event of a violation of at least one access right to the resource by a transaction, to generate a first error signal representative of the violated access right to the resource, and a second error signal representative of at least one access right of this transaction.

### CROSS-REFERENCE TO RELATED APPLICATIONS

This application claims the priority benefit of French Patent Application No. 2212349, filed on Nov. 25, 2022, which application is hereby incorporated by reference herein in its entirety.

### TECHNICAL FIELD

Embodiments and implementations relate to techniques for isolating resources belonging to a system-on-chip and are provided for security or reliability purposes.

### BACKGROUND

More specifically, in terms of reliability, for example, to help ensure the trustworthiness of a system-on-chip, or in terms of security, for example, to help protect secret information, the access of one or more primary (i.e., master) device to specific slave (i.e., auxiliary) resources may need to be restricted. Such a restriction is referred to by a person skilled in the art as “isolation”.

For example, the publication FR 3103586 A1 (28May 2021) describes a technique for managing these access restrictions that is simple to set up and to implement, in particular when this management is dynamic, i.e. when it depends on different applications of the system-on-chip.

In particular, security-enabled systems-on-chips conventionally include a secure environment and a non-secure environment, each of which can have a privilege or non-privilege state. Moreover, the resources (for example, primary devices and slave devices) of this type of system-on-chip can be isolated via compartmentalization. These three “security-privilege-compartmentalization” dimensions allow certain reliability or security resources to be isolated. To access the resources, rules are defined according to “access rights” corresponding to a “security-privilege-compartmentalization” trio for each resource.

If the access rights rules are violated, it is important that this is notified to record the event and take all necessary measures. The detection and processing of illegal access, for example, such as that described in the publication FR 3103586 A1 (28May 2021), allows such violations to be detected.

However, in conventional isolation techniques, the management of illegal access events is centralized by a central processing unit in a “trusted domain” (for example, the secure environment in the privilege state of a so-called “trusted” central microprocessor).

According to a conventional example in an “asymmetric” multi-microprocessor architecture (i.e. where one of the microprocessors is considered hierarchically superior to the others in terms of security and is labeled as “trusted”), the communication of illegal access events between the trusted microprocessor and the others is typically complex and slowed down by functional latencies.

According to another conventional example in a “symmetric” multi-microprocessor architecture (i.e. where the microprocessors have no particular hierarchy therebetween and none are labeled as “trusted”), the communication of illegal access events may not be possible as the objective is typically to provide completely independent microprocessor domains.

There is thus a need to provide a solution for distributing access rights violation events to the respective microprocessors and operating systems affected by these events.

### SUMMARY

Embodiments and implementations propose using a resource isolation system to generate new signals to identify which attributes (security, privilege, or compartmentalization attributes) of the access rights are concerned by a violation event involving access rights to a resource.

Embodiments and implementations propose using the resource isolation system to generate new interrupts to one or more microprocessors to inform the operating system (OS) concerned with the existence and attributes of an access rights violation event.

According to one aspect, the invention proposes a system-on-chip including at least one microprocessor domain including a microprocessor and at least one resource; and a resource isolation system including a filtering circuit for each resource and configured to detect security, privilege, and optionally compartmentalization access rights violation for the resource, by transactions arriving at the resource, the filtering circuit being configured, in the event of a violation of at least one access right to the resource by a transaction, to generate a first error signal representative of the violated access right to the resource, and a second error signal representative of at least one access right of this transaction.

More specifically, it should be noted that the aspect defined hereinabove can apply without necessarily providing for compartmentalization access rights.

For example, the second error signal is advantageously representative of at least one access right other than the violated access right to the resource. For example, the second error signal is advantageously representative of at least the security access right of the transaction. For example, the second error signal is advantageously representative of the security and compartmentalization access rights of the transaction.

Security and privilege access rights are well-known concepts to a person skilled in the art. For example, for a microprocessor in secure mode, an operating system can be used with resources that are not accessible in a non-secure mode. In the privilege mode, the microprocessor can have privilege rights to access resources that it will not have in the non-privilege mode.

The compartmentalization access right allows, for example, at least one primary device to be assigned to at least some of the resources (slaves), or at least some of the resources to be assigned to at least one primary device. Compartmentalization access rights in particular apply when the system-on-chip includes a plurality of microprocessor domains, as well as a plurality of primary devices in one and the same domain, such as a microprocessor and a direct memory access (DMA) circuit for example.

Thus, the first error signal and the second error signal, combined with knowledge of the isolation rules defined by the access rights, can advantageously be used to deduce whether the access rights violation event occurred between the secure environment and the non-secure environment, or between the privilege state and the non-privilege state in the non-secure environment, or between the privilege state and the non-privilege state in the secure environment, as well as to identify the origin of the transaction causing the event.

According to one embodiment, the resource isolation system further includes an illegal access controller configured to code, based on the first error signal and the second error signal, in a status register readable to the microprocessor, a violation of the security access rights to a resource, a violation of the privilege access rights to a resource of a secure environment, and a violation of the privilege access rights to a resource of a non-secure environment.

According to one embodiment, the illegal access controller is configured to communicate a first interrupt to a non-secure environment of the microprocessor, or a second interrupt to a secure microprocessor environment, depending on the access rights violation case detected.

According to one embodiment, the illegal access controller is configured to generate the first interrupt upon violation of the access rights to a resource of the non-secure environment and to generate the second interrupt upon violation of the access rights to a resource of the secure environment.

According to one embodiment, the filtering circuit is configured, upon violation of the security or privilege access rights to a resource by a transaction, to generate the second error signal representative of the security access right of this transaction.

According to one embodiment, the system-on-chip includes the first microprocessor domain and at least one second microprocessor domain, and the resources of the first microprocessor domain and of the at least one second microprocessor domain have respective compartmentalization access rights.

According to one embodiment, the first microprocessor domain is labelled as trusted, and the illegal access controller is configured to code, in the status register, which is readable to the microprocessor of the first trusted domain, each of the cases of violation of the access rights to a resource of any of the domains, by a transaction initiated from any of the domains.

According to one embodiment, the illegal access controller is configured to communicate the first interrupt and the second interrupt to the microprocessor of the first trusted domain.

According to one embodiment, the illegal access controller is configured to code, in a status register dedicated to each of the domains, which is readable to the microprocessor of the respective domain, each of the cases of violation of the access rights to a resource of any of the domains, by a transaction initiated from the respective domain.

According to one embodiment, the illegal access controller is configured to communicate the first interrupt and the second interrupt to the microprocessor of the respective domain.

According to one embodiment, the first microprocessor domain is labelled as trusted, and the illegal access controller is configured to communicate a third interrupt to the microprocessor of the first trusted domain, upon detection of a compartmentalization access rights violation.

According to one embodiment, the filtering circuit is configured, upon violation of the security or privilege access rights to a resource by a transaction, to generate the second error signal which is also representative of the compartmentalization access right of this transaction.

According to another aspect, the invention proposes a method for managing the resource isolation of a system-on-chip, wherein: the system-on-chip comprises at least one microprocessor domain including a microprocessor and at least one resource; and the method comprises, for each resource, detecting a security, privilege and optionally compartmentalization access rights violation for the resource, by transactions arriving at the resource, and, in the event of violation of at least one access right to the resource by a transaction, generating a first error signal representative of the violated access right to the resource, and a second error signal representative of at least one access right of this transaction.

According to one implementation, the method further comprises coding, based on the first error signal and the second error signal, in a status register readable to the microprocessor, a violation of the security access rights to a resource, a violation of the privilege access rights to a resource of a secure environment, and a violation of the privilege access rights to a resource of a non-secure environment.

According to one implementation, the method further comprises communicating a first interrupt to a non-secure environment of the microprocessor, or a second interrupt to a secure environment of the microprocessor, depending on the access rights violation case detected.

According to one implementation, the first interrupt is generated upon violation of the access rights to a resource of the non-secure environment, and the second interrupt is generated upon violation of the access rights to a resource of the secure environment.

According to one implementation, upon violation of the security or privilege access rights to a resource by a transaction, the second error signal is representative of the security access right of this transaction.

According to one implementation, the system-on-chip includes the first microprocessor domain and at least one second microprocessor domain, and the resources of the first microprocessor domain and the at least one second microprocessor domain have respective compartmentalization access rights.

According to one implementation, where the first microprocessor domain is labelled as trusted, the coding is carried out in the status register, which is readable to the microprocessor of the first trusted domain, for each of the cases of violation of the access rights to a resource of any of the domains, by a transaction initiated from any of the domains.

According to one implementation, the first interrupt and the second interrupt are communicated to the microprocessor of the first trusted domain.

According to one implementation, the coding is carried out in a status register dedicated to each of the domains, which is readable to the microprocessor of the respective domain, for each of the cases of violation of the access rights to a resource of any of the domains, by a transaction initiated from the respective domain.

According to one implementation, the first interrupt and the second interrupt are communicated to the microprocessor of the respective domain.

According to one implementation, where the first microprocessor domain is labelled as trusted, the method further comprises communicating a third interrupt to the microprocessor of the first trusted domain, upon detection of a compartmentalization access rights violation.

According to one implementation, upon violation of the security or privilege access rights to a resource by a transaction, the second error signal is also representative of the compartmentalization access right of this transaction.

### BRIEF DESCRIPTION OF THE DRAWINGS

Examining the detailed description of non-limiting embodiments and implementations, and from the accompanying drawings in which:

FIG. 1 is an example of a system-on-chip;

FIG. 2 is an “asymmetric” multi-core architecture;

FIG. 3 is a “symmetric” multi-core architecture;

FIG. 4 is an example of a filtering circuit;

FIG. 5A is a logic operation of a logic circuit;

FIG. 5B is a logic operation of a second logic circuit;

FIG. 5C is a logic operation of a third logic circuit;

FIG. 6 is an embodiment of a resource isolation system;

FIG. 7A is a logic operation of a logic circuit;

FIG. 7B is a logic operation of a second logic circuit;

FIG. 8 is an example of a filtering circuit; and

FIG. 9 is an example of an illegal access controller.

### DETAILED DESCRIPTION OF EMBODIMENTS

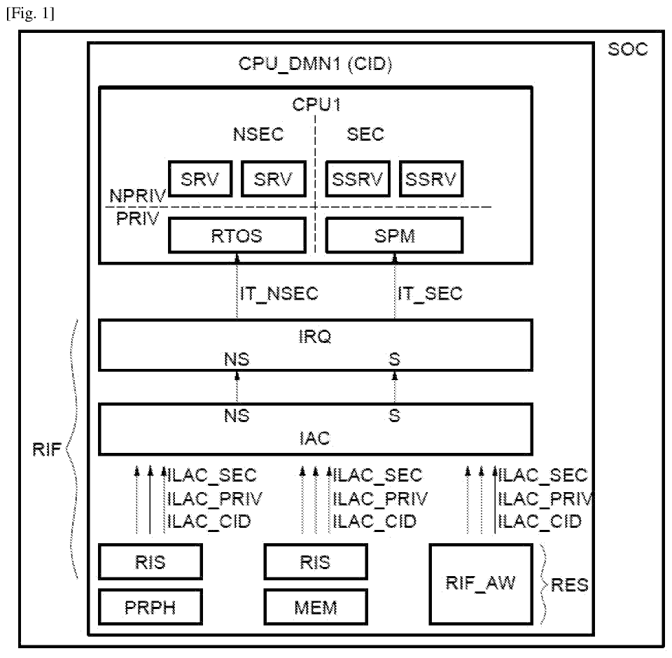

FIG. 1 shows an example of a system-on-chip SOC including a microprocessor domain CPU_DMN1 and a resource isolation system RIF.

The microprocessor domain CPU_DMN1 includes a central processing unit CPU1, referred to as the microprocessor, and one or more resources PRPH, MEM, RIF_AW, which will also be referred to as a resource RES.

For example, the resources RES of the system-on-chip SOC can include peripherals PRPH of the I2C (Inter-Integrated Circuit) type, SPI (Serial Peripheral Interface) type, UART (Universal Asynchronous Receiver Transmitter) type, or internal memories MEM or interfaces for external memories.

The microprocessor CPU1 includes a secure environment SEC and a non-secure environment NSEC, which can cumulatively have a privilege state PRIV or non-privilege state NPRIV.

For example, secure services SSRV and services SRV can be implemented in the non-privilege state NPRIV of the secure environment SEC and non-secure environment NSEC; real-time operating system RTOS (for example, for real-time control of an external device) can be implemented in the non-secure domain NSEC in the privilege state PRIV, and the software part concerning the management of the secure environment SPM can be implemented in the secure domain SEC in the privilege state PRIV.

Moreover, a compartmentalization identification CID allows, for example, an assignment of the microprocessor CPU1 (or another primary device of the system-on-chip SOC, such as, for example, a direct memory access “DMA” circuit) to at least some of the resources PRPH, MEM, RIF_AW to be defined, or an assignment of at least some of the resources PRPH, MEM, RIF_AW to the microprocessor (or to another primary device) to be defined.

The three dimensions are security SEC, privilege PRIV, and compartmentalization CID allows certain resources RES to be isolated for reliability or security reasons.

To access the resources RES, rules are defined according to “access rights” corresponding to a security SEC, privilege PRIV, and compartmentalization CID trio for each resource RES.

The primary devices of the domain CPU_DMN1, i.e. the microprocessor CPU1 for example, are able to initiate a transaction with the slave devices of the domain CPU_DMN1, i.e. the resources RES.

For example, a transaction has the same security SEC, privilege PRIV, and compartmentalization CID access rights as the primary device that generated it.

The transactions are communicated over an integrated circuit bus (not shown), typically an Advanced High-performance Bus (AHB), and more comprehensively via an interconnection network of the system-on-chip SOC.

The resource isolation system RIF is configured to implement resource isolation as a function of the security access rights SEC, NSEC, privilege access rights PRIV, NPRIV, and compartmentalization access rights CID of each resource PRPH, MEM, RIF_AW. The resource isolation system RIF is in particular able to detect a violation of the access rights by transactions arriving at the resources.

In this respect, the resource isolation system RIF includes a filtering circuit RIS for each resource PRPH, MEM, and, for example, an illegal access controller IAC and an interrupt controller IRQ.

The filtering circuit RIS can, for example, be produced by a dedicated circuit, located between the respective resource PRPH, MEM, and the interconnection network or the “AHB,” or be integrated into the resource RIF_AW, which can thus be labeled as “resource isolation aware”.

The resource isolation system RIF is not exclusively dedicated to a microprocessor domain CPU_DMN1, and, in the event that the system-on-chip SOC includes a plurality of domains, the resource isolation system RIF is common to the plurality of domains and in particular allows for the isolation of resources between respective domains.

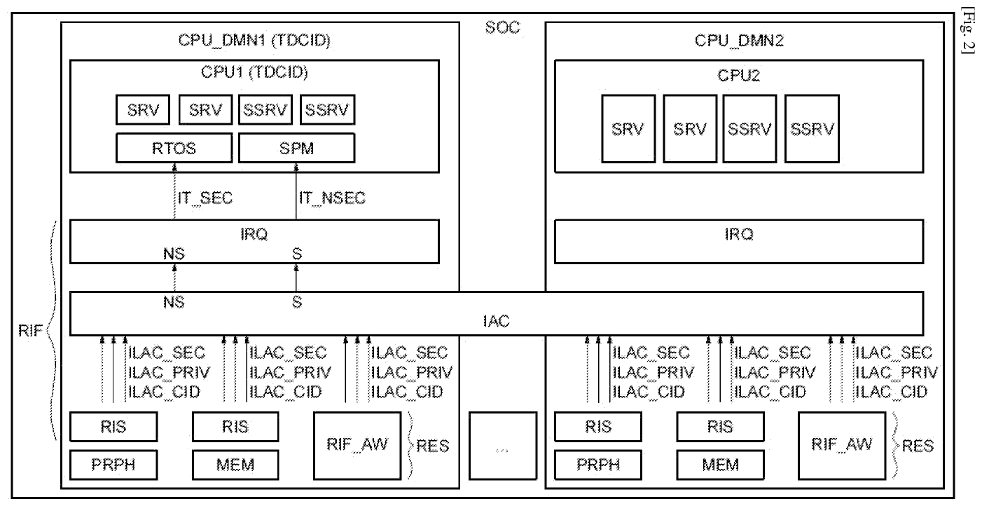

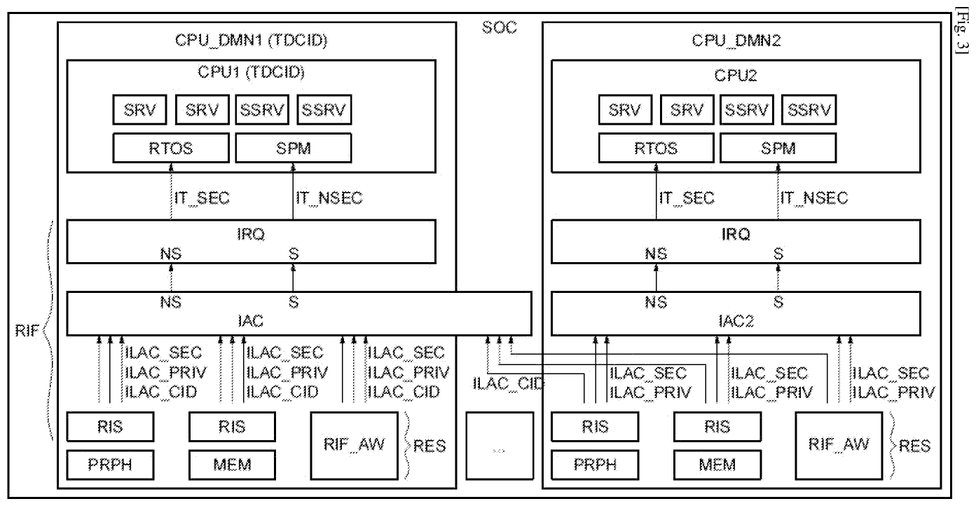

Reference is made to FIGS. 2 and 3, which illustrate examples where the system-on-chip SOC, as described with reference to FIG. 1, includes the first microprocessor domain CPU_DMN1 and additionally at least one second microprocessor domain CPU_DMN2. These cases of systems-on-chips SOC that include a plurality of microprocessors CPU1 and CPU2 can be labeled as “multi-core”.

The resources of the first microprocessor domain CPU_DMN1 and the at least one second microprocessor domain CPU_DMN2 can have respective compartmentalization access rights CID1 and CID2 for each domain.

The case shown in FIG. 2 corresponds to an “asymmetric” multi-core architecture wherein the second microprocessor CPU2 is only intended to provide non-privilege (NPRIV) services, in the non-secure environment SRV or secure environment SSRV. Alternatively, the asymmetry can stem from the fact that the second microprocessor CPU2 is only intended to provide non-secure services (NSEC), according to non-privilege or privilege states.

As a result, the first microprocessor CPU1 has a higher isolation capability than the second microprocessor CPU2, and the first microprocessor CPU1, as well as the first domain CPU_DMN1, are labelled as “trusted” TDCID.

The case shown in FIG. 3 corresponds to a “symmetric” multi-core architecture wherein the second microprocessor CPU2 is configured to be substantially identical to the first microprocessor CPU1, in particular with regard to the configuration of the secure/non-secure environments and cumulatively the privilege/non-privilege states.

For example, the description given so far with reference to FIGS. 1 to 3 of the resource isolation systems RIF can correspond to the resource isolation technique described in the publication FR 3103586 A1 (28 May 2021) to which a person skilled in the art will be able to refer for any purpose.

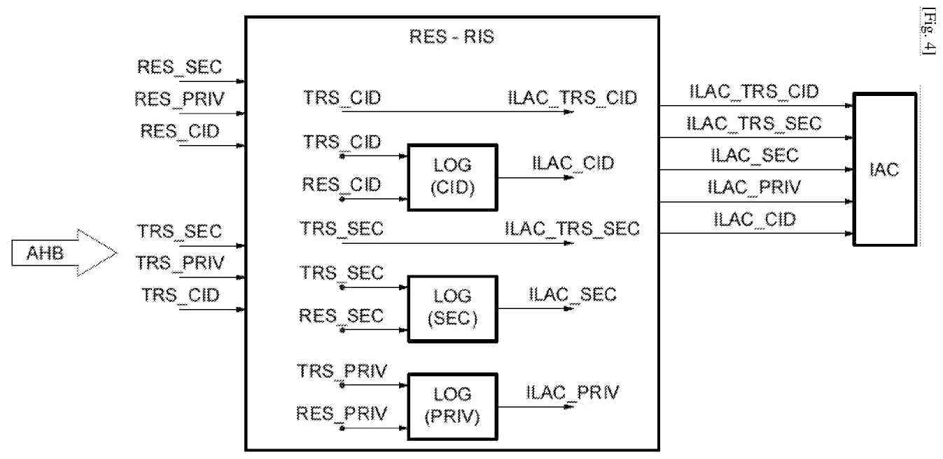

Furthermore, in each of the cases shown in FIGS. 1 to 3, the filtering circuit RIS of each resource is advantageously configured, in the event of violation of at least one access right to the resource by a transaction, to generate a first error signal ILAC_SEC, ILAC_PRIV, ILAC_CID representative of the violated access right to the resource, and a second error signal ILAC_TRS_SEC, ILAC_TRS_CID (FIG. 4) representative of at least one access right of this transaction TRS_SEC, TRS_CID (FIG. 4).

For example, the second error signal TRS_SEC, TRS_CID can represent at least one access right other than the violated access right to the resource ILAC_SEC, ILAC_PRIV, ILAC_CID. For example, the second error signal ILAC_TRS_SEC is advantageously representative of at least the security access right of the transaction TRS_SEC. For example, the second error signal ILAC_TRS_CID can also be representative of the compartmentalization access right of the transaction TRS_CID. For example, “the second error signal” can be considered to contain both the error signal ILAC_TRS_SEC representative of the security access right of the transaction TRS_SEC and the error signal ILAC_TRS_CID representative of the compartmentalization access right of the transaction TRS_CID.

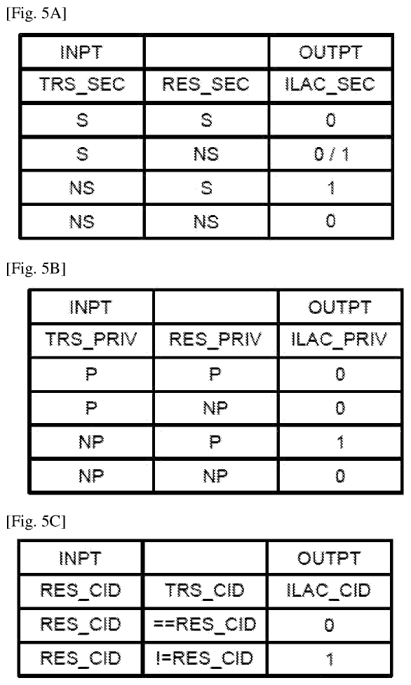

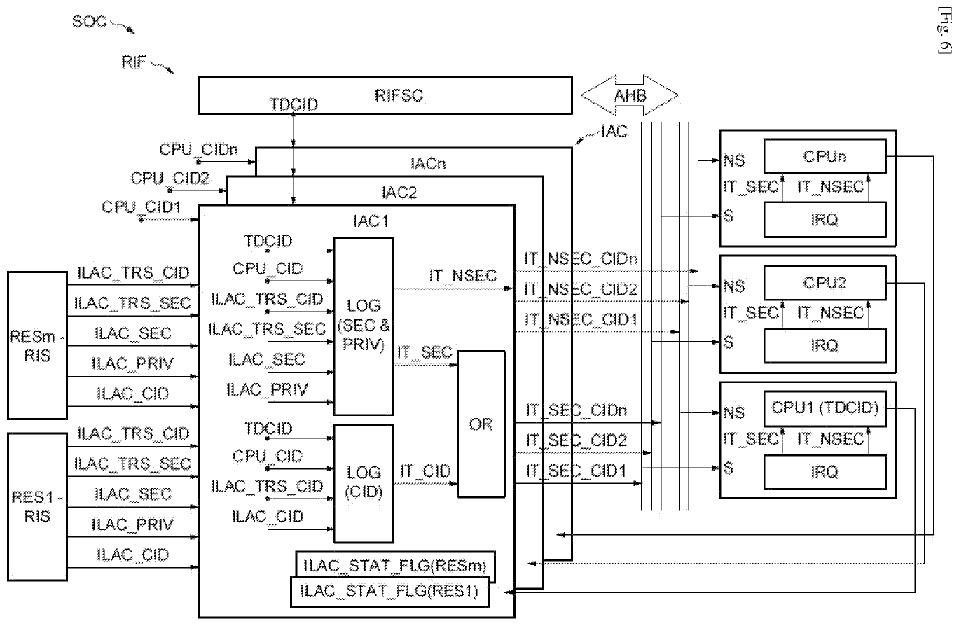

The mechanism implemented by the filtering circuit RIS will be described in more detail hereinbelow with reference to FIG. 4 and FIG. 5A-5C.

The error signals ILAC_SEC, ILAC_PRIV, ILAC_CID, ILAC_TRS_SEC, and ILAC_TRS_CID can be communicated to the illegal access controller IAC.

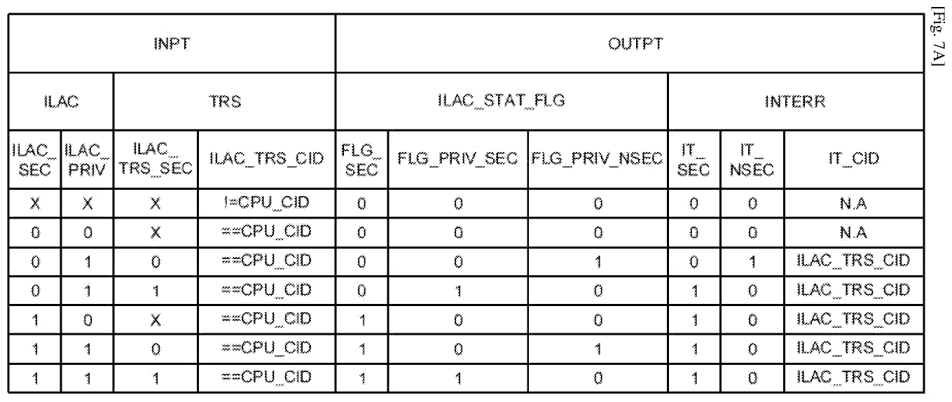

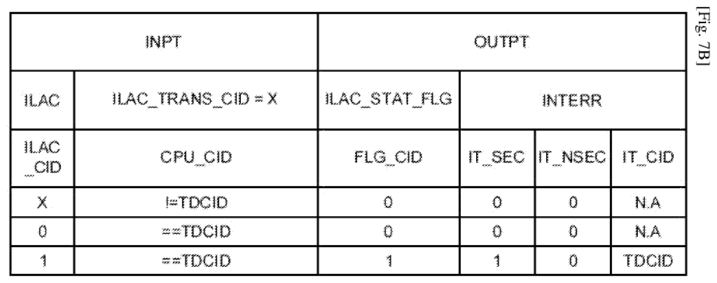

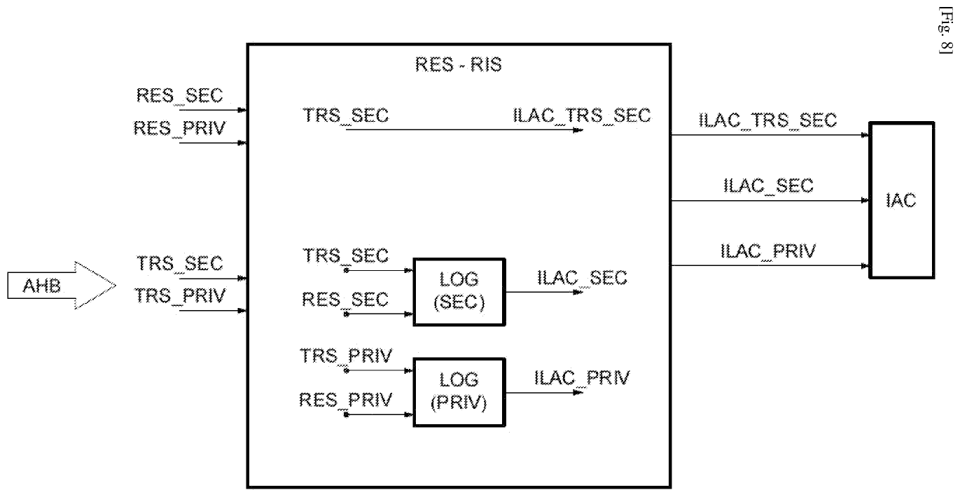

Based on the error signals ILAC_SEC, ILAC_PRIV, ILAC_CID, ILAC_TRS_SEC, ILAC_TRS_CID, the illegal access controller IAC is advantageously configured to code, in a status register ILAC_STAT_FLG (FIG. 6) readable to the microprocessor CPU1, a numeric information item (for example, in 3 bits) representative of the following violation cases, which can be cumulated: a violation of the security access rights to a resource FLG_SEC; a violation of the privilege access rights to a resource of a secure environment FLG_PRIV_SEC; and a violation of the privilege access rights to a resource of a non-secure environment FLG_PRIV_NSEC (FIG. 7A).

Furthermore, depending on the one or more detected cases of access rights violations FLG_SEC, FLG_PRIV_SEC, FLG_PRIV_NSEC, the illegal access controller IAC is advantageously configured to communicate, for example, via the interrupt controller IRQ, a first interrupt IT_NSEC to the non-secure environment NSEC of the relevant microprocessor CPU1/CPU2, or a second interrupt IT_SEC to the secure environment SEC of the relevant microprocessor CPU1/CPU2.

In the case shown in FIG. 1, the relevant microprocessor is the only microprocessor CPU1 of the system-on-chip SOC. In the case shown in FIG. 2, the relevant microprocessor can be the first trusted microprocessor CPU1. In the case shown in FIG. 3, the relevant microprocessor CPU1/CPU2 can be that belonging to the domain CPU_DMN1/CPU_DMN2 from which the transaction causing the violation originated or potentially to the trusted domain TDCID.

Thus, the resource isolation system RIF described hereinabove advantageously allows the relevant environment of the microprocessor to be notified directly, depending on the particular access rights violation detected.

In other words, the resource isolation system RIF is able to establish accurate identification information and communicate it to the primary device entity best qualified to take action and manage the violation, and in particular without systematically using the secure environment in the privilege state.

The mechanism implemented by the illegal access controller IAC will be described in more detail hereinbelow with reference to FIG. 6 and FIG. 7A-7B.

FIG. 4 shows an example of one of the filtering circuits RIS dedicated to each resource RES, to generate the first error signals ILAC_SEC, ILAC_PRIV, ILAC_CID and the second error signals ILAC_TRS_SEC, ILAC_TRS_CID.

This example applies in particular, but not necessarily, to the context of a symmetric multi-core architecture described with reference to FIG. 3.

On the one hand, the resource isolation system RIF is configured to provide the filtering circuit RIS with information on the security access rights level RES_SEC, privilege access rights level RES_PRIV and compartmentalization access rights level RES_CID of the respective resource RES.

On the other hand, the filtering circuit RIS can, for example, be connected between the bus AHB routing the transactions and the resource RES, so as to acquire information on the security access right level TRS_SEC, privilege access right level TRS_PRIV and compartmentalization access right level TRS_CID of the transactions arriving at this resource RES.

The filtering circuit RIS includes a first logic circuit LOG (SEC), configured to generate the first error signal related to the security access right ILAC_SEC, which is conditional on the value of the security access right to the resource RES_SEC and the value of the security access right of the transaction TRS_SEC.

Reference is made to FIG. 5A to describe the logic operations of the first logic circuit LOG (SEC).

The security access rights to the resource RES_SEC and of the transaction TRS_SEC can take a value S representing the secure level, or a value NS representing the non-secure level. This value is, for example, coded in 1 bit.

The first logic circuit LOG (SEC) is configured according to the truth table in FIG. 5A, i.e. to generate, at the output OUTPT, the error signal ILAC_SEC at a first value, for example, “1,” when the inputs INPT communicate that a non-secure level NS transaction TRS_SEC has reached the secure level S resource RES_SEC.

Moreover, when the resource RES is a memory MEM, the error signal ILAC_SEC is generated at the first value “1,” when the inputs INPT communicate that a secure level S transaction TRS_SEC has reached the non-secure level NS resource RES_SEC.

The error signal ILAC_SEC is not generated or is generated at a second value, for example, “0,” in all other possible cases for the input values INPT.

Reference is made again to FIG. 4. The filtering circuit RIS includes a second logic circuit LOG (PRIV), configured to generate the first error signal related to the privilege access right ILAC_PRIV, which is conditional on the value of the privilege access right to the resource RES_PRIV and the value of the privilege access right of the transaction TRS_PRIV.

Reference is made to FIG. 5B to describe the logic operations of the second logic circuit LOG (PRIV).

The privilege access rights to the resource RES_PRIV and of the transaction TRS_PRIV can take a value P representing the privilege level, or a value NP representing the non-privilege level NS. This value is, for example, coded in 1 bit.

The second logic circuit LOG (PRIV) is configured according to the truth table in FIG. 5B, i.e. to generate, at the output OUTPT, the error signal ILAC_PRIV at the first value of “1” when the inputs INPT communicate that a non-secure level NS transaction TRS_SEC has reached the secure level S resource RES_SEC.

The error signal ILAC_SEC is not generated or is generated at the second value of “0” in all other possible cases for the input values INPT.

Reference is made again to FIG. 4.

The filtering circuit RIS includes a third logic circuit LOG (CID), configured to generate the first error signal related to the compartmentalization violation ILAC_CID, which is conditional on the compartmentalization identifier of the resource RES_CID and the compartmentalization identifier of the transaction TRS_CID.

Reference is made to FIG. 5C to describe the logic operations of the third logic circuit LOG (CID).

The second logic circuit LOG (CID) is configured according to the truth table in FIG. 5C, i.e. to generate, at the output OUTPT, the error signal ILAC_CID at the first value of “1” when the inputs INPT communicate that the compartment identifier of the transaction TRS_CID is not the same as that of the resource “!=RES_CID”.

The error signal ILAC_CID is not generated, or is generated at the second value of “0,” when the compartment identifier of the transaction TRS_CID is the same as that of the resource “==RES_CID”.

Reference is made again to FIG. 4.

The filtering circuit RIS is further configured to transfer the value S, or NS, of the security access right of the transaction TRS_SEC to provide the second error signal ILAC_TRS_SEC.

The filtering circuit RIS can also be configured to transfer the compartmentalization identifier of the transaction TRS_CID to provide the second error signal ILAC_TRS_CID.

It should in particular be noted that the filtering circuit RIS is configured, upon violation of the privilege access rights PRIV, NPRIV to the resource by a transaction, to generate the second error signal ILAC_SEC representative of the security access right of this transaction ILAC_TRS_SEC.

In particular, the illegal access controller IAC can, for example, distinguish whether a violation of the privilege access rights PRIV/NPRIV occurs in the secure environment SEC or the non-secure environment NSEC.

Moreover, it will also be possible to distinguish more particularly whether a transaction that is illegal in terms of the privilege access right originates from a secure environment.

Reference is made, in this respect, to FIGS. 6 and 7A-7B.

FIG. 6 shows an example embodiment of the resource isolation system RIF, in particular the illegal access controller IAC.

This example applies in particular, but not necessarily, to the context of a symmetric multi-core architecture described with reference to FIG. 3.

In this example, the system-on-chip SOC includes a number “n” of microprocessors CPU1, CPU2, CPUn, and of associated domains, each having a respective compartmentalization identifier CPU_CID1, CPU_CID2, CPU_CIDn; and a number “m” of resources RES1, RESm, each having a filtering circuit RIS as described hereinabove with reference to FIG. 4.

The illegal access controller IAC receives and processes the first and second error signals ILAC_SEC, ILAC_PRIV, ILAC_CID, ILAC_TRS_SEC, ILAC_TRS_CID originating from all of the filtering circuits RIS of the various resources RES1-RESm, in a manner specific to each microprocessor domain, for example, by illegal access sub-controllers IAC1, IAC2, IACn specific to each domain.

In practice, the illegal access sub-controllers IAC1, IAC2, and IACn are not necessarily sectorised in the overall illegal access control circuit IAC.

The illegal access controller IAC can include a logic circuit LOG (SEC & PRIV) for managing security and privilege violations, and a logic circuit LOG (CID) for managing compartmentalization violations.

Based on the error signals ILAC_SEC, ILAC_PRIV, ILAC_CID, ILAC_TRS_SEC, ILAC_TRS_CID, the illegal access controller IAC (the logic circuit “LOG (SEC & PRIV)”) is advantageously configured to code, in a status register ILAC_STAT_FLG, a numeric information item (for example, in 3 bits) representative of at least the following violation cases, which are optionally cumulated: a violation of the security access rights to a resource FLG_SEC; a violation of the privilege access rights to a resource of a secure environment FLG_PRIV_SEC; and a violation of the privilege access rights to a resource of a non-secure environment FLG_PRIV_NSEC (FIG. 7A).

For example, the status register ILAC_STAT_FLG includes sub-registers respectively dedicated to each of the resources RES1-RESm. For example, the status register ILAC_STAT_FLG is readable to the microprocessor CPU1-CPUn belonging to the same domain as the illegal access sub-controller IAC1-IACn.

Furthermore, the illegal access controller IAC is configured to communicate a first interrupt IT_NSEC or a second interrupt IT_SEC to the non-secure environment NSEC or secure environment SEC of the microprocessor CPU1, depending on the detected case of access rights violation FLG_SEC, FLG_PRIV_SEC, FLG_PRIV_NSEC (see FIG. 7A).

The illegal access controller IAC can more particularly be configured to communicate the first interrupt IT_NSEC_CID1-IT_NSEC_CIDn and the second interrupt IT_SEC_CID1-IT_SEC_CIDn, respectively to the non-secure environment NS and to the secure environment S of the microprocessor CPU1-CPUn of the domain corresponding to the transaction causing the violation.

As mentioned hereinabove, the interrupts IT_NSEC_CID1-IT_NSEC_CIDn, IT_SEC_CID1-IT_SEC_CIDn can be communicated via the bus AHB and via the interrupt controller IRQ, in particular via the non-secure environment NS and secure environment S of the interrupt controller IRQ respectively.

Reference is made to FIG. 7A to describe the logic operations of the logic circuit LOG (SEC & PRIV) for managing security and privilege violations of the controller IAC.

The logic circuit LOG (SEC & PRIV) is configured according to the truth table in FIG. 7A, i.e. to generate two types of outputs OUTPT, from the aforementioned error signals at the input INPT.

It should be recalled that the first error signals ILAC are representative of a resource security violation if ILAC_SEC=1 or of a resource privilege violation if ILAC_PRIV=1.

It should be recalled that one of the second error signals TRS is representative of the secure level S security access right of the transaction TRS_SEC if ILAC_TRS_SEC=1 and the non-secure level NS security access right of the transaction TRS_SEC if ILAC_TRS_SEC=0; and that the other of the second error signals TRS is representative of the compartmentalization identifier of the transaction ILAC_TRS_CID, i.e. the compartmentalization identifier CPU_CID1-CPU_CIDn (FIG. 6) of the domain from which this transaction originates.

On the one hand, the outputs OUTPT of the logic circuit LOG (SEC & PRIV) include the numeric information from the status register ILAC_STAT_FLG, for example, coded in 3 bits, representative of the aforementioned violation cases, i.e.: a violation of the security access rights to a resource if a first bit FLG_SEC is “1”; a violation of the privilege access rights to a resource of a secure environment if a second bit FLG_PRIV_SEC is “1”; and a violation of the privilege access rights to a resource of a non-secure environment if a third bit FLG_PRIV_NSEC is “1”.

On the other hand, the outputs OUTPT of the logic circuit LOG (SEC & PRIV) include the first interrupt IT_NSEC and the second interrupt IT_SEC generated when equal to “1” and communicated to the domain corresponding to the compartmentalization identifier IT_CID communicated in the second error signal ILAC_TRS_CID.

The first row of the truth table in FIG. 7A means that no output OUTPT is generated when the compartmentalization identifier of the transaction ILAC_TRS_CID does not match that of the domain “!=CPU_CID” of this sub-controller IAC1-IACn.

The second row of the truth table in FIG. 7A means that no output OUTPT is generated when no violation is detected ILAC_SEC=0, ILAC_PRIV=0 for this resource.

The third row of the truth table in FIG. 7A means that at the output OUTPT, the interrupt of the non-secure environment is generated IT_NSEC=1 and the status register ILAC_STAT_FLG contains a code representative of a privilege violation for a non-secure resource FLG_PRIV_NSEC=1; when at the input INPT, there is a privilege violation ILAC_PRIV=1 but no security violation ILAC_SEC=0, by a non-secure transaction ILAC_TRS_SEC=0.

The fourth row of the truth table in FIG. 7A means that at the output OUTPT, the interrupt of the secure environment is generated IT_SEC=1 and the status register ILAC_STAT_FLG contains a code representative of a privilege violation for a secure resource FLG_PRIV_SEC=1; when at the input INPT, there is a privilege violation ILAC_PRIV=1 but no security violation ILAC_SEC=0, by a secure transaction ILAC_TRS_SEC=1.

The fifth row of the truth table in FIG. 7A means that at the output OUTPT, the interrupt of the secure environment is generated IT_SEC=1 and the status register ILAC_STAT_FLG contains a code representative of a security violation for a resource FLG_SEC=1; when at the input INPT, there is a security violation ILAC_SEC=1 but no privilege violation ILAC_PRIV=0, by a transaction of any security level ILAC_TRS_SEC=X.

The sixth row of the truth table in FIG. 7A means that at the output OUTPT, the interrupt of the secure environment is generated IT_SEC=1 and the status register ILAC_STAT_FLG can contain a code representative of a security and privilege violation for a non-secure resource FLG_SEC=1, FLG_PRIV_NSEC=1; when at the input INPT, there is a security violation ILAC_SEC=1 and a privilege violation ILAC_PRIV=1, by a non-secure transaction ILAC_TRS_SEC=0.

However, in this case, in practice, the privilege violation for the resource could be not coded (i.e. FLG_SEC=1, and FLG_PRIV_NSEC=0), to limit the complexity of the information provided. More specifically, processing the security violation can be considered hierarchically superior to processing the privilege violation.

The seventh row of the truth table in FIG. 7A means that at the output OUTPT, the interrupt of the secure environment is generated IT_SEC=1 and the status register ILAC_STAT_FLG contains a code representative of a security and privilege violation for a secure resource FLG_SEC=1, FLG_PRIV_SEC=1; when at the input INPT, there is a security violation ILAC_SEC=1 and a privilege violation ILAC_PRIV=1, by a secure transaction ILAC_TRS_SEC=1.

However, in this case, in practice, the privilege violation for the resource could be not coded (i.e. FLG_SEC=1, and FLG_PRIV_SEC=0), to limit the complexity of the information provided. More specifically, processing the security violation can again be considered hierarchically superior to processing the privilege violation.

For example, the following three cases could be coded in the status register ILAC_STAT_FLG: a privilege violation for a non-secure resource (i.e. non-privilege, non-secure access to a privilege, non-secure resource) with the bit FLG_PRIV_NSEC=1; or a privilege violation for a secure resource (i.e. non-privilege, secure access to a privilege, secure resource) with the bit FLG_PRIV_SEC=1; or a security violation for a resource (i.e. non-secure access to a secure resource, of the peripheral or memory type, or secure access to a non-secure memory) with the bit FLG_SEC=1.

Reference is made again to FIG. 6.

In the symmetric multi-core system-on-chip SOC, the first microprocessor CPU1 can, in addition, and in particular, be labelled as “trusted” and will be notified of the violation of the access rights regarding the compartmentalization identifiers CID.

The illegal access controller IAC includes, in this respect, the logic circuit LOG (CID) for managing the compartmentalization violations ILAC_CID, and is, for example, informed of the identification of the trusted domain TDCID, by a control circuit RIFSC of the resource isolation system RIF.

The illegal access controller IAC (the logic circuit LOG (CID) for managing the compartmentalization violations) is configured to communicate a third interrupt IT_SEC_CID1 to the microprocessor CPU1 of the first trusted domain TDCID, upon detection of a compartmentalization access rights violation ILAC_CID. Advantageously, the third interrupt IT_SEC_CID1 is communicated to the secure environment S of the microprocessor CPU1 of the first trusted domain TDCID.

Reference is made to FIG. 7B to describe the logic operations of the logic circuit LOG (CID) for managing the compartmentalization violations for the controller IAC.

The logic circuit LOG (CID) is configured according to the truth table in FIG. 7B, meaning on the one hand that no output OUTPT is generated in the absence of a compartmentalization violation ILAC_CID=0 and when the compartmentalization identifier of the sub-controller CPU_CID does not correspond to that of the trusted domain TDCID, “CPU_CID!=TDCID”.

The truth table in FIG. 7B, on the other hand, means that the third secure environment interrupt IT_CID is generated to the microprocessor CPU1 of the trusted domain TDCID if a compartmentalization access rights violation by a transaction is detected “ILAC_CID=1,” regardless of the identifier of this transaction “ILAC_TRS_CID=X”.

However, in the alternative embodiments described hereinabove with reference to FIG. 1 and with reference to FIG. 2, there is in particular no specific condition regarding the compartmentalization identifier “ILAC_TRS_CID” and all of the outputs OUTPT of the logic circuits LOG (SEC & PRIV), LOG (CID) of the illegal access controller IAC are communicated to the microprocessor CPU1 of the trusted domain TDCID.

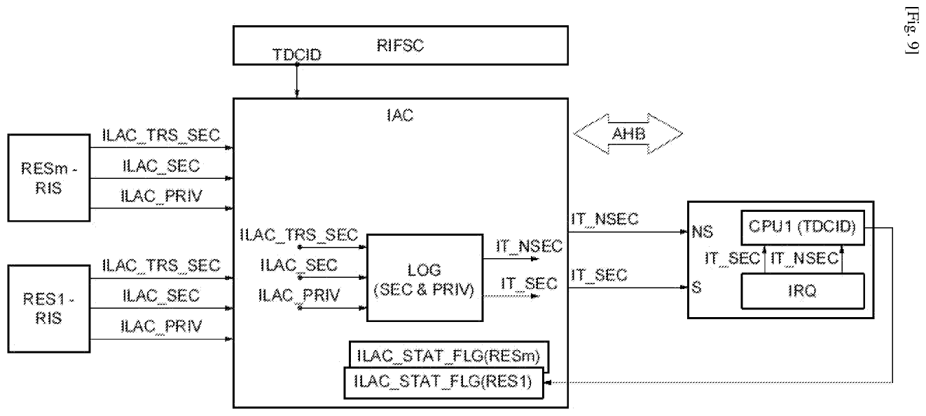

Reference is made, in this respect, to FIGS. 8 and 9.

FIG. 8 illustrates an example of a filtering circuit RES-RIS of a resource RES, whereas FIG. 9 illustrates an example of an illegal access controller IAC; which are particularly adapted to the case of the single-core alternative embodiment (with a single microprocessor CPU1) described with reference to FIG. 1, and to the case of the asymmetric multi-core alternative embodiment described with reference to FIG. 2.

It should be recalled that these two cases do not take into account any specific condition regarding the compartmentalization identifier ILAC_TRS_CID and all of the outputs OUTPT of the logic circuits LOG (SEC) LOG (PRIV) are communicated to the microprocessor CPU1 of the (“first”) trusted domain TDCID.

Thus, on the one hand, the filtering circuit RIS in FIG. 8 includes the first logic circuit LOG (SEC) configured according to the truth table in FIG. 5A, the second logic circuit LOG (PRIV) configured according to the truth table in FIG. 5B, as described hereinabove with reference to FIG. 4, and does not necessarily include the third logic circuit LOG (CID). The filtering circuit RIS is further configured to transfer the value of the security access right of the transaction TRS_SEC to provide the second error signal ILAC_TRS_SEC.

Moreover, on the other hand, the illegal access controller IAC in FIG. 9 is configured such that the status register ILAC_STAT_FLG, ILAC_STAT_FLG is readable to the microprocessor CPU1 of the (“first”) trusted domain TDCID, and contains the numeric information representative of the cases of violations regarding all resources RES1-RESm of any of the domains, by a transaction initiated from any of the domains.

Furthermore, the illegal access controller IAC is configured such that the first interrupt IT_NSEC and the second interrupt IT_SEC are always communicated to the microprocessor CPU1 of the (“first”) trusted domain TDCID.

In the alternative embodiment corresponding to the asymmetric multi-core architecture described hereinabove with reference to FIG. 2, the logic operations of the logic circuit LOG (CID) for managing the compartmentalization violations of the controller IAC are also defined by the truth table in FIG. 7B.

Finally, in the case shown in FIG. 1 or 2, a violation of the compartmentalization access right ILAC_CID could nevertheless be detected by the resource filtering circuit RES-RIS and communicated to the illegal access controller IAC. In particular, the illegal access controller can be configured, in the event of a compartmentalization violation, to generate an interrupt IT_SEC to the secure environment of the (“first”) microprocessor CPU1 of the trusted domain TDCID.

What is claimed is:

1. A system-on-chip (SoC), comprising:
a microprocessor domain comprising a microprocessor and an auxiliary resource; and
a resource isolation circuit comprising a filtering circuit for the auxiliary resource, the resource isolation circuit configured to detect a violation of a security access right, a privilege access right, a compartmentalization access right, or a combination thereof, for transactions arriving at the auxiliary resource,
wherein the filtering circuit is configured to generate, in response to detecting a violation of an access right to the auxiliary resource by a transaction arriving at the auxiliary resource, a first error signal and a second error signal, the first error signal indicating the violation, and the second error signal indicating an access right corresponding to the transaction.

2. The SoC of claim 1, wherein the resource isolation circuit further comprises an illegal access controller configured to:
code a violation of a security access right in a status register readable by the microprocessor in response to the first error signal and the second error signal;
code a violation of a privilege access right to a resource of a secure environment of the microprocessor; and
code a violation of the privilege access right to a resource of a non-secure environment of the microprocessor.

3. The SoC of claim 2, wherein the illegal access controller is configured to, based on a type of the access right detected to be violated:
communicate a first interrupt signal to the non-secure environment of the microprocessor; or
communication a second interrupt signal to the secure environment of the microprocessor.

4. The SoC of claim 3, wherein the illegal access controller is configured to:
generate the first interrupt signal in response to detecting a violation of the access rights to a resource of the non-secure environment; and
generate the second interrupt signal in response to detecting a violation of the access rights to a resource of the secure environment.

5. The SoC of claim 1, wherein the filtering circuit is configured, in response to detecting a violation of the security access right or a violation of the privilege access right, generate the second error signal indicating a security access right corresponding to the transaction.

6. The SoC of claim 1, wherein the microprocessor domain is a first microprocessor domain, the SoC further comprising a second microprocessor domain, wherein each of a resource of the first microprocessor domain and a resource of the second microprocessor domain has a respective compartmentalization access right.

7. The SoC of claim 6, wherein the first microprocessor domain is a trusted domain, wherein the resource isolation circuit further comprises an illegal access controller configured to code a status register readable by the trusted domain for each case of a violation of access rights to a resource of any one of the first microprocessor domain or the second microprocessor domain by a transaction initiated from any one of the first microprocessor domain or the second microprocessor domain.

8. The SoC of claim 7, wherein the illegal access controller is configured to, based on a type of the access right detected to be violated:
communicate a first interrupt signal to the trusted domain; or
communication a second interrupt signal to the trusted domain.

9. The SoC of claim 6, wherein the resource isolation circuit further comprises an illegal access controller configured to code, in a status register dedicated to a respective one of the first microprocessor domain and the second microprocessor domain, each of the cases of violation of access rights to an auxiliary resource of any one of the first microprocessor domain or the second microprocessor domain, by a transaction initiated from a respective one of the first microprocessor domain or the second microprocessor domain, the status register being readable to the respective one of the microprocessor of the first microprocessor domain and the second microprocessor domain.

10. The SoC of claim 6, wherein the resource isolation circuit further comprises an illegal access controller configured to, based on a type of the access right detected to be violated:
communicate a first interrupt signal to a non-secure environment of the first microprocessor domain or the second microprocessor domain; or
communication a second interrupt signal to a secure environment of the first microprocessor domain or the second microprocessor domain.

11. The SoC of claim 6, wherein the first microprocessor domain is a trusted domain, wherein the resource isolation circuit further comprises an illegal access controller configured to communicate a third interrupt signal to the microprocessor of the trusted domain based on detecting a violation of the compartmentalization access rights.

12. The SoC of claim 1, wherein the filtering circuit is configured, in response to detecting a violation of the security access right or a violation of the privilege access right to an auxiliary resource by a transaction, generate the second error signal indicating a security access right corresponding to the transaction and a compartmentalization access right corresponding to the transaction.

13. A method, comprising:
detecting, by a filtering circuit of a resource isolation circuit in a system-on-chip (SoC), a violation of a security access right, a privilege access right, a compartmentalization access right, or a combination thereof, for transactions arriving at an auxiliary resource of a microprocessor domain of the SoC, the microprocessor domain further comprising microprocessor; and
generating, by the filtering circuit, in response to detecting a violation of an access right to the auxiliary resource by a transaction arriving at the auxiliary resource, a first error signal and a second error signal, the first error signal indicating the violation, and the second error signal indicating an access right corresponding to the transaction.

14. The method of claim 13, further comprising:
coding, by an illegal access controller of the resource isolation circuit, code a violation of a security access right in a status register readable by the microprocessor in response to the first error signal and the second error signal;
coding, by the illegal access controller, a violation of a privilege access right to a resource of a secure environment of the microprocessor; and
coding, by the illegal access controller, a violation of the privilege access right to a resource of a non-secure environment of the microprocessor.

15. The method of claim 14, further comprising:
communicating, by the illegal access controller, a first interrupt signal to the non-secure environment of the microprocessor based on a type of the access right detected to be violated; or
communicating, by the illegal access controller, a second interrupt signal to the secure environment of the microprocessor based on a type of the access right detected to be violated.

16. The method of claim 15, further comprising:
generating the first interrupt signal in response to detecting a violation of the access rights to a resource of the non-secure environment; and
generating the second interrupt signal in response to detecting a violation of the access rights to a resource of the secure environment.

17. The method of claim 13, further comprising generating, by the filtering circuit, in response to detecting a violation of the security access right or a violation of the privilege access right, the second error signal indicating a security access right corresponding to the transaction.

18. The method of claim 13, wherein the microprocessor domain is a first microprocessor domain, the SoC further comprising a second microprocessor domain, wherein each of a resource of the first microprocessor domain and a resource of the second microprocessor domain has a respective compartmentalization access right.

19. The method of claim 18, wherein the first microprocessor domain is a trusted domain, wherein the resource isolation circuit further comprises an illegal access controller configured to code a status register readable by the trusted domain for each case of a violation of access rights to a resource of any one of the first microprocessor domain or the second microprocessor domain by a transaction initiated from any one of the first microprocessor domain or the second microprocessor domain.

20. A device comprising a system-on-chip (SoC), the SoC comprising:
a microprocessor domain comprising a microprocessor and an auxiliary resource; and
a resource isolation circuit comprising a filtering circuit for the auxiliary resource, the resource isolation circuit configured to detect a violation of a security access right, a privilege access right, a compartmentalization access right, or a combination thereof, for transactions arriving at the auxiliary resource,
wherein the filtering circuit is configured to generate, in response to detecting a violation of an access right to the auxiliary resource by a transaction arriving at the auxiliary resource, a first error signal and a second error signal, the first error signal indicating the violation, and the second error signal indicating an access right corresponding to the transaction.
